(19) United States
(12) Patent Application Publication
(10) Pub. No.: US 2019/0379920 A1
(43) Pub. Date: Dec. 12, 2019

(54) METHOD AND SYSTEM FOR CREATING A CUSTOMIZED VIDEO ASSOCIATED WITH AN ADVERTISEMENT

(71) Applicant: TP Vision Holding B.V., Amsterdam (NL)

(72) Inventor: Gyana Ranjan SENAPATI, Bangalore (IN)

(21) Appl. No.: 16/003,045

(22) Filed: Jun. 7, 2018

(51) Int. Cl. H04N 21/234; H04N 21/81; H04N 21/4223

(52) U.S. Cl. CPC H04N 21/23424; H04N 21/441; H04N 21/4223; H04N 21/812

(57) ABSTRACT

A method for creating a customized video associated with an advertisement is implemented using a processor controlling a recording device. The method includes: after receiving a user command for recording a source video, controlling the recording device to start recording the source video as a recorded video; determining a selected advertisement; and processing the recorded video to create a customized video based on the recorded video and the selected advertisement. During playback of the customized video, the selected advertisement is displayed at a specific time instance.

### FIELD

The disclosure relates to a method and a system for creating a customized video associated with a selected advertisement.

### BACKGROUND

Chinese Patent Application No. 201410012657.X discloses a method and a device for recommending a product associated with a television program. In the method, the device obtains information regarding the television program, and subsequently obtains information regarding a product that is related to the television program.

### SUMMARY

One object of the disclosure is to provide a method that is capable of creating a customized video for viewing by a user.

According to one embodiment of the disclosure, the method is for creating a customized video associated with an advertisement. The method is implemented using a processor controlling a recording device, and includes:

after receiving a user command for recording a source video, controlling the recording device to start recording the source video as a recorded video;

determining a selected advertisement; and

processing the recorded video to create the customized video having information associated with the selected advertisement, such that during playback of the customized video, the selected advertisement is displayed at a specific time instance.

Another object of the disclosure is to provide a system that is capable of implementing the above-mentioned method.

According to one embodiment of the disclosure, the system is for creating a customized video associated with an advertisement. The system includes a processor and a recording device controlled by the processor.

The processor is programmed to, in response of a user command for recording a source video, control said recording device to start recording the source video as a recorded video, to determine a selected advertisement, and to process the recorded video to create the customized video having information associated with the selected advertisement, such that during playback of the customized video, the selected advertisement is displayed at a specific time instance.

### BRIEF DESCRIPTION OF THE DRAWINGS

Other features and advantages of the disclosure will become apparent in the following detailed description of the embodiments with reference to the accompanying drawings, of which:

FIG. 1 is a block diagram of a system configured for creating a customized video associated with an advertisement, according to one embodiment of the disclosure;

FIG. 2 is a flow chart illustrating steps of a method for creating a customized video associated with an advertisement, according to one embodiment of the disclosure;

FIG. 3 is a flow chart illustrating steps for collecting user preference information regarding a watching habit of a user;

FIG. 4 is a flow chart illustrating steps for processing a recorded video to create the customized video; and

FIG. 5 is a flow chart illustrating steps for collecting user preference information regarding a watching habit of a user with respect to the customized video.

### DETAILED DESCRIPTION

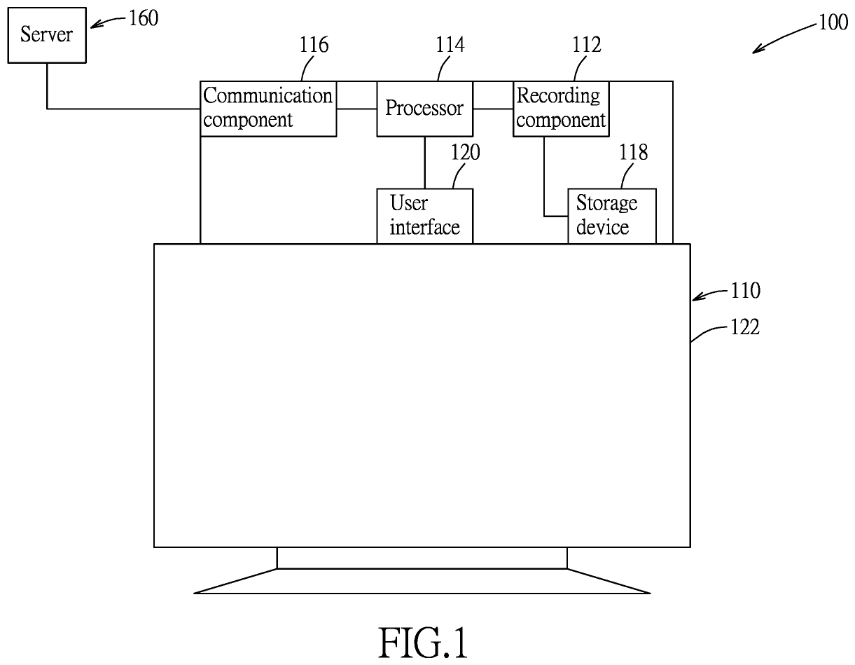

FIG. 1 is a block diagram illustrating a system 100 for creating a customized video associated with advertisement, according to one embodiment of the disclosure.

In this embodiment, the system 100 includes an electronic device 110, and a server 160.

The electronic device 110 may be embodied using a television (TV) set, a personal computer, a smart phone, a tablet, or a laptop, etc., and includes a recording component 112, a processor 114, a communication component 116, a storage device 118, a user interface 120, and a display 122.

The recording component 112 may be embodied using a personal video recorder (PVR), and is capable of recording a source video. In embodiments of the disclosure, the source video may be a television program received via a cable (i.e., cable television program), radio waves (i.e., broadcast television), or an antenna (i.e., satellite television). Additionally, the source video may be in the form of streaming media received via a network such as the Internet. Regardless of the type of transmission scheme used to receive the source video or program, the source video or program is said to be “broadcasted” by its source throughout this disclosure.

The processor 114 is capable of executing one or more software applications including instructions that, when executed, cause the processor 114 to perform certain operations. The processor 114 may refer to any device or portion of a device that processes electronic data from registers and/or memory to transform that electronic data into other electronic data. For example, the processor 114 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The communication component 116 is capable of communicating with the server 160 over a network (e.g., the Internet) using wired or wireless communication for data transmission therebetween. The communicating component 116 may include a short-range wireless communicating module supporting a short-range wireless communication network using a wireless technology of Bluetooth® and/or Wi-Fi, etc., and a mobile communicating module supporting telecommunication using Long-Term Evolution (LTE), the third generation (3G) and/or fourth generation (4G) of wireless mobile telecommunications technology, and/or the like.

The storage device 118 stores at least one software program installed in the electronic device 110. The software program may be an operating system (OS) or other applications providing the electronic device 110 with various functionalities. Additionally, the software applications and the source video recorded by the recording component 112 may be stored in the storage device 118. For example, the storage device 118 may include any non-transitory memory mechanism, such as read-only memory (ROM), random-access memory (RAM), magnetic disk storage media, optical storage media, flash memory, solid state devices (SSD), and other storage devices and media.

In embodiments where the electronic device 110 is embodied using a TV set, the recording component 112, the processor 114, the communication component 116 and the storage device 118 may be integrated into a set-top box.

The user interface 120 is capable of receiving commands from a user in the form of electrical signals. Specifically, the user interface 120 may be embodied using a remote control, a keyboard/mouse, a stylus pen, an audio recorder, the display 122, or a combination thereof. The display 122 may for instance be an LCD (liquid crystal display), a touch screen display, etc.

Upon powering on the electronic device 110, the processor 114 may require a user to complete an authentication operation (i.e., to “sign-up” as a registered user, or to “login” as a registered user). In this manner, when a video program is selected to be broadcasted by the electronic device 110, the processor 114 may associate the video program with the registered user that is logged in at the time.

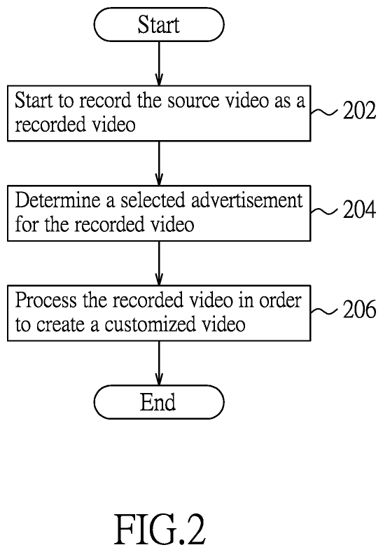

FIG. 2 is a flowchart illustrating steps of a method for creating a customized video that is associated with an advertisement, according to one embodiment of the disclosure. In this embodiment, the method is implemented using the system 100 as shown in the embodiment of FIG. 1.

When the user intends to record a source video for watching later, he/she may operate the user interface 120 to transmit a user command to the electronic device 110. In use, when the user is to use a scheduled-recording feature to record a program that is scheduled to be broadcasted at a later time, the user command may include a channel selection and/or a time slot that indicates a time period during which the program is to be broadcasted. Alternatively, when the user is to record a program that is currently being broadcasted, he/she may operate the user interface 120 transmit the user command that controls the electronic device 110 to start recording immediately.

In response to the user command, in step 202, the processor 114 starts to record the source video as a recorded video.

After starting with the recording, in step 204, the processor 114 determines a selected advertisement for the recorded video.

In use, the determination of the selected advertisement may be done in a number of ways.

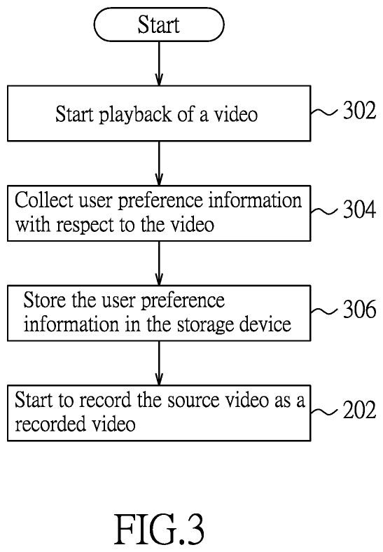

In one embodiment, the processor 114 is programmed to, prior to the implementation of the method, collect user preference information regarding a watching habit of the user, and the determining of the selected advertisement is executed based on the user preference information. As shown in FIG. 3, in step 302, the user controls the electronic device 110 to start playback of a video. In response, in step 304, the processor 114 collects user preference information with respect to the video.

Specifically, the user preference information may include one or more of the following: a viewing history that lists at least one watched video that was previously watched; a record history that lists at least one previously recorded video; and a geographical location of the recording device (the electronic device 110), which may be derived from, for example, an Internet Protocol (IP) address.

In use, the viewing history for the watched video(s), which is included in the user preference information, may be in the form of a reference data structure including one or more entries. The entries may include information such as a time and a duration in which the watched video was played, at least one genre of the watched video, an identifier related to the watched video, a viewing pattern including a rate of repetition at which the watched video or a similar video deemed to be similar to the watched video was played, and user reaction to the watched video.

The following Table 1 illustrates an exemplary reference data structure of a viewing history recorded for a particular watched video.

TABLE 1

| Country | Region | Genre1 to 2 | SubGenre1 to n | Identifier1 to n | RepRate | Reaction |
|---|---|---|---|---|---|---|
| Taiwan | 3 | Comedy | Action | Jay Chou | High | Positive |

To construct the reference data structure, some of the above information may be obtained from an event information table or a content descriptor included in an electronic program guide (EPG) provided by, for example, a television provider.

Specifically, each watched video may be categorized into one or more genres and one or more subgenres. Furthermore, content of the watched video may be associated with one or more identifiers (e.g., an artist, a specific object or location, a character, an event, a song, etc.).

It is noted that in some embodiments, the content of the watched video may be determined by performing at least one of video fingerprinting and audio fingerprinting on the watched video so as to obtain the above information. This may be implemented when the EPG is not available.

The rate of repetition at which the watched video (and/or the similar video) is played may be calculated by the processor 114. Specifically, the processor 114 is programmed to record data regarding the viewing of the watched video. For example, when the electronic device 100 is a television set, the data may indicate whether the watched video is played in whole or in part(s) (e.g., based on whether the user has switched to other channels).

The reaction of the user with respect to the watched video may be obtained in a number of ways. For example, the reaction may be manually inputted by the user as feedback. In embodiments where a facial detection camera is present, the facial detection camera may be configured to capture an image of the facial expression of the user periodically, while the watched video is being played. Afterward, the processor 114 may analyze the images thus captured to determine the reaction of the user.

It is noted that the user preference information may be further associated with the registered user, in order to create the user preference information that is more personalized with respect to any individual user.

In step 306, the processor 114 stores the user preference information in the storage device 118.

Based on the above, by collecting the user preference information, the processor 114 may determine what kind(s) of content is more “preferable” to the user, and determine the selected advertisement accordingly.

In one embodiment, the server 160 stores a plurality of candidate advertisements therein. Each of the plurality of candidate advertisements is associated with a metadata structure. The following Table 2 illustrates an exemplary metadata structure for a particular candidate advertisement.

TABLE 2

| | | | | Artist/ | Other |
|---|---|---|---|---|---|
| | | | Sub | Brand_Ambassador | Identifiers 1- |
| Country | Region | Genre | Genre | 1/2 | to N |
| Taiwan | 3 | Comedy | Action | Jay Chou | Motorcycle |

As such, the determining of the selected advertisement may include obtaining a plurality of match scores, each by comparing the reference data structure, which is created based on the user preference information, with the metadata structure for a respective one of the plurality of candidate advertisements. Afterward, the selected advertisement is determined based on the match scores thus obtained with respect to the respective candidate advertisements.

In some embodiments, each entry of the reference data structure may be given a specific weight in obtaining the match score. For example, when it is determined that the user is more interested in videos featuring a specific artist (as evidenced by the user watching such videos more often and/or having a positive reaction), then, in obtaining the match score, any candidate advertisement featuring the same artist as a brand ambassador may be given a higher match score, which means that such candidate advertisement is more likely to be determined as the selected advertisement.

Alternatively, when it is determined that the user is more interested in videos of a specific genre, in obtaining the match score, any candidate advertisement categorized in a similar genre may be given a higher match score.

In some embodiments, the processor 114 is programmed to, as the source video is being recorded, obtain source information regarding the source video in a manner similar to obtaining the user preference information for the watched video (e.g., collect the relevant information from the EPG), and to create a source data structure based on the source information. The source data structure may have a form that is similar to that depicted in the above Table 1. Afterward, the source data structure may be utilized for comparison with the metadata structures for the plurality of candidate advertisements so as to obtain the corresponding match scores. In some embodiments, the source data structure may be incorporated into the reference data structure and utilized for comparison with the metadata structures for the plurality of candidate advertisements to obtain the match scores.

It is noted that step 204 may be implemented by the processor 114 (i.e., the electronic device 110 obtains the metadata structure for each of the plurality of candidate advertisements from the server 160, and subsequently performs the comparing of the reference structure and the metadata structures and the determining of the selected advertisement), or by a processor included in the server 160 (i.e., the electronic device 110 transmits the reference data structure to the server 160 for the processor of the server 160 to perform the comparing of the reference structure and the metadata structures and the determining of the selected advertisement).

In some embodiments, the selected advertisement is chosen from a group of preset advertisements from an advertisement source such as a specific sponsor or an advertisement buyer.

After the selected advertisement is determined, in step 206, the processor 114 processes the recorded video in order to create a customized video. Specifically, the customized video incorporates the recorded video and data associated with the selected advertisement, such that during playback of the customized video, the selected advertisement is displayed at a specific time instance.

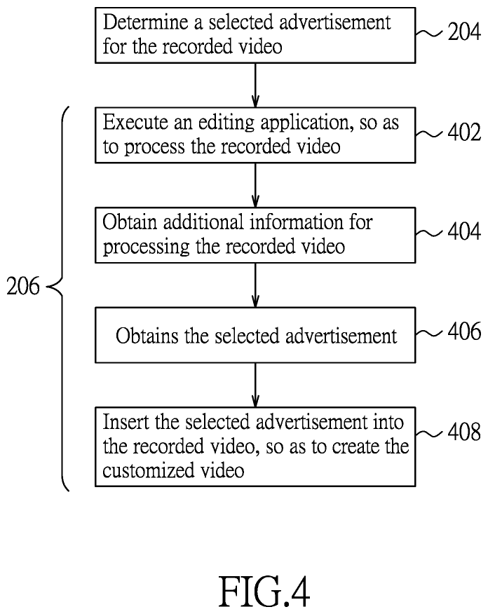

As shown in FIG. 4, the processing of the recorded video may include the following sub-steps.

In sub-step 402, the processor 114 executes an editing application, so as to process the recorded video.

In sub-step 404, the processor 114 obtains additional information for processing the recorded video. For example, the additional information may include a current time, the content of the recorded video (determined by video/audio fingerprinting), etc.

In sub-step 406, the processor 114 obtains the selected advertisement. In this embodiment, the selected advertisement is obtained from the server 160.

In sub-step 408, the processor 114 “inserts” the selected advertisement into the recorded video, so as to create the customized video.

Specifically, in this embodiment, the selected advertisement is merged into the recorded video. In one example, the recorded video has a length of 30 minutes, the selected advertisement has a length of 1 minute, and the specific time instance is 00:10:00 (hh:mm:ss). As such, the customized video has a length of 31 minutes, and during playback of the customized video, at the 10-minute mark, the content of the recorded video is cut and the content of the selected advertisement is played. After the display of the selected advertisement is completed at the 11-minute mark, playing of the content of the recorded video is resumed.

In other embodiments, sub-step 408 involves inserting, at the specific time instance, a pointer that is associated with the selected advertisement. The pointer may lead to the selected advertisement, such that during the playback of the customized video, when the specific time instance (e.g., the 10-minute mark) is reached, the pointer is triggered and the playback of the customized video is interrupted, and the selected advertisement is displayed instead. After the display of the selected advertisement is completed, playback of the customized video is resumed.

In some embodiments, sub-step 408 involves enabling a skip function, so as to interrupt the display of the selected advertisement and resume playback of the customized video in response to a user-input skip command received during display of the selected advertisement.

In the above example involving merging of the selected advertisement into the recorded video, the skip function may be available after the selected advertisement has been displayed for a predetermined time (e.g., 5 seconds) As such, at 00:10:05, the user may operate the user interface 120 to skip the selected advertisement and the playback is moved to 00:11:00.

It is noted that in some embodiments, the processing of the recorded video is executed during the recording of the source video. This may be referred to as an online mode.

Alternatively, in other embodiments, the processing of the recorded video is executed after the recording of the source video is completed. This may be referred to as an offline mode. It is noted that the words “online” and “offline” as used herein do not necessarily mean that the electronic device 110 is or is not connected to the network.

Using the above procedure, the customized video is then stored in the storage device 118 and becomes available for viewing by the user.

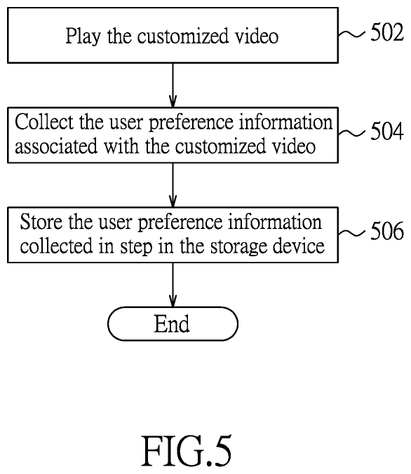

As shown in FIG. 5, in step 502, the user may operate the user interface 120 to execute a video playing application, and to play the customized video.

In response, during the playback of the customized video, the processor 114 is programmed to collect the user preference information associated with the customized video in step 504. It is noted that the user preference information collected may include reaction of the user associated with the selected advertisement.

In step 506, the processor 114 stores the user preference information collected in step 504 in the storage device 118.

To sum up, the embodiments of the disclosure provides a method for creating a customized video that is associated with a selected advertisement. As such, the selected advertisement, which is specifically chosen to potentially fit the interest of the user, may be efficiently incorporated into playback of the recorded video for viewing, even though the source video (e.g., a television broadcast program, an online stream, etc.) may be recorded without an advertisement. In this manner, the release of the advertisement may be more targeted to the individual users, as compared to the conventional advertising.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for creating a customized video associated with an advertisement, the method being implemented using a processor controlling a recording device and comprising:
after receiving a user command for recording a source video, controlling the recording device to start recording the source video as a recorded video;
determining a selected advertisement; and
processing the recorded video to create the customized video having information associated with the selected advertisement, such that during playback of the customized video, the selected advertisement is displayed at a specific time instance.

2. The method of claim 1, further comprising, prior to determining the selected advertisement:
collecting user preference information regarding a watching habit of a user;
wherein, the determining of the selected advertisement is executed based on the user preference information.

3. The method of claim 2, wherein the user preference information includes at least one of the following:
a viewing history that lists at least one watched video that is previously watched, wherein for the watched video, the viewing history includes
a time at which the watched video was played and a duration the watched video was played for,
at least one genre of the watched video,
an identifier related to the watched video,
a viewing pattern including a rate of repetition at which the watched video or a similar video deemed to be similar to the watched video was played, and
user reaction to the watched video;
a record history that lists at least one previously recorded video; and
a geographical location of the recording device.

4. The method of claim 3, the processor communicating with a storage device that stores a plurality of candidate advertisements therein, each of the plurality of candidate advertisements being associated with a metadata structure, wherein the determining of the selected advertisement includes creating a reference data structure based on the user preference information, obtaining a plurality of match scores, each by comparing the reference data structure with the metadata structure for a corresponding one of the plurality of candidate advertisements, and determining the selected advertisement based on the match scores thus obtained.

5. The method of claim 2, further comprising:
determining content of the source video by performing at least one of video fingerprinting or audio fingerprinting on the source video.

6. The method of claim 5, wherein the determining of the selected advertisement is executed further based on the content of the source video.

7. The method of claim 1, wherein the selected advertisement is chosen from a group of preset advertisements from an advertisement source.

8. The method of claim 1, wherein the processing of the recorded video is executed during the recording of the source video.

9. The method of claim 1, wherein the processing of the recorded video is executed after the recording of the source video is completed.

10. The method of claim 1, wherein the processing of the recorded video to create the customized video includes inserting the selected advertisement at the specific time instance of the recorded video.

11. The method of claim 1, wherein the processing of the recorded video to create the customized video includes inserting at the specific time instance of the recorded video, a pointer that is associated with the selected advertisement, such that the playback of the customized video is interrupted at the specific time instance to switch to displaying the selected advertisement, and the playback of the customized video is resumed after the display of the selected advertisement is completed.

12. The method of claim 11, wherein the processing of the recorded video further includes enabling a skip function for interrupting the display of the selected advertisement, and resuming playback of the customized video in response to a user-input skip command received during display of the selected advertisement.

13. A system for creating a customized video associated with an advertisement, comprising a processor and a recording device controlled by said processor,
wherein said processor is programmed to, in response of a user command for recording a source video, control said recording device to start recording the source video as a recorded video, to determine a selected advertisement, and to process the recorded video to create the customized video having information associated with the selected advertisement, such that during playback of the customized video, the selected advertisement is displayed at a specific time instance.

14. The system of claim 13, wherein said processor is programmed to, prior to determining the selected advertisement, collect user preference information regarding a watching habit of a user, wherein, said processor determines the selected advertisement based on the user preference information.

15. The system of claim 14, wherein the user preference information includes at least one of the following:
a viewing history that lists at least one watched video that is previously watched, wherein for the watched video, the viewing history includes
a time at which the watched video was played and a duration for which the watched video was played,
at least one genre of the watched video,
an identifier related to the watched video,
a viewing pattern including a rate of repetition at which the watched video or a similar video deemed to be similar to the watched video was played, and
user reaction to the watched video;
a record history that lists at least one previously recorded video; and
a geographical location of said recording device.

16. The system of claim 15, further comprising a storage device that stores a plurality of candidate advertisements therein, each of the plurality of candidate advertisements being associated with a metadata structure,
wherein said processor is programmed to determine the selected advertisement by said processor creating a reference data structure based on the user preference information, said processor obtaining match scores each through comparing the reference data structure with the metadata structure for a corresponding one of the plurality of candidate advertisements, and said processor determining the selected advertisement based on the match scores thus obtained.

17. The system of claim 13, wherein said processor is further programmed to determine content of the source video by performing at least one of video fingerprinting or audio fingerprinting on the source video, and said processor determines the selected advertisement further based on the content of the source video.

18. The system of claim 13, wherein the selected advertisement is chosen by said processor from a group of preset advertisements from an advertisement source.

19. The system of claim 13, wherein said recording device is a personal video recorder (PVR).
